(19) United States
(12) Patent Application Publication
(10) Pub. No.: US 2026/0066626 A1
(43) Pub. Date: Mar. 5, 2026

(54) AIR CONDITIONER ARRANGEMENT WITH THERMAL CONDUCTION HEAT EXCHANGER

(71) Applicant: Pfannenberg GmbH, Hamburg (DE)

(72) Inventor: Torben WAGNER, Hamburg (DE)

(73) Assignee: Pfannenberg GmbH, Hamburg (DE)

(21) Appl. No.: 19/308,971

(22) Filed: Aug. 25, 2025

(30) Foreign Application Priority Data
Aug. 27, 2024 (DE) 20 2024 104 817.2

(51) Int. Cl. H02B 1/56

(52) U.S. Cl. CPC H02B 1/565

(57) ABSTRACT

An air conditioner arrangement for a switch cabinet enabling operation with a combustible and/or toxic coolant, the arrangement including a housing with a cabinet side housing area and an external housing area, having a partition wall therebetween, which fluidically separates the cabinet side housing area and the external housing area, and including an air-liquid heat exchanger extending through the partition wall, with an evaporator section in the external housing area and with a heat absorption section coupled thermally with the evaporator section and arranged in the cabinet side housing area to take up the heat from the cabinet side housing area and transfer it to the evaporator section by thermal conduction, wherein a coolant circuit containing a combustible and/or toxic coolant, is arranged in the external housing area, such that the heat from the cabinet side housing area delivered to the evaporator section can be transferred to the coolant circuit.

### CROSS REFERENCE TO RELATED APPLICATION

This application claims the benefit of German Patent Application Serial No. 202024 104 817.2 filed on August 27, 2024, which is herein incorporated by reference in its entirety.

### TECHNICAL FIELD

The present invention relates to an air conditioner arrangement and a switch cabinet containing such an air conditioner arrangement.

### Technological background

A switch cabinet of the type discussed here accommodates a multiplicity of electronic components that are configured to control a process plant, a machine tool or some other manufacturing device. Typically installed electronic components include in particular power lines, terminals, resistors, capacitors, diodes, transistors, inductors, integrated circuits, relays, sensors, and many more. During specified normal operation of such a switch cabinet, heat is generated and must be dissipated effectively in order to ensure the long-term functional capability of the electrical components. In a conventional switch cabinet, a heat exchanger is often installed for this purpose, with a pipe system that is configured to transport a coolant, and includes multiple pipe pieces as well as multiple pipe bends, wherein the pipe bends each connect two end sections of two pipe pieces to each other in fluid-conducting manner. In this respect, the pipe system forms a pipe coil, in which a coolant circulates, taking up heat inside the switch cabinet and dissipating the heat outside the switch cabinet. In order to remove the heat effectively, an airflow is created in an internal circuit of the switch cabinet and impinges on the heat exchanger. This internal circuit is shielded from the external circuit, so that no gases can get into the internal circuit of the switch cabinet from the external circuit.

According to the prior art, the use of fluorinated coolants with greenhouse potential as coolant is known in particular, but although these gases are advantageous for thermodynamic reasons with regard to heat dissipation, in the event of a leak they are discharged into the surrounding atmosphere, which is linked to adverse effects for the climate. Areas of such a pipe system that are particularly prone to leaks are for example pipe bends with a curvature of more than 90°, and connection points, particularly soldered joints, between the pipe bends and the pipe pieces. The use of fluorinated coolants must therefore be discontinued sooner rather than later, and for this reason they will have to be replaced with alternative coolants in future.

Alternative coolants that can be used to good effect for thermodynamic reasons, are usually combustible and/or highly flammable or exhibit high operating pressures in transcritical operation. In order to be able to use such coolants in the switch cabinet air conditioning system safely and in compliance with regulations, it is essential for the design of the internal circuit of the switch cabinet in particular to be inherently safe. In this context, it must be ensured that escaping coolant, particularly in the area of the evaporator, does not produce an explosive atmosphere even in the event of a leak, as this might be ignited by an electronic component in the switch cabinet.

### DESCRIPTION OF THE INVENTION: OBJECT, SOLUTION, ADVANTAGES

The object underlying the invention is to provide an air conditioner arrangement for a switch cabinet that enables explosion-proof operation of the air conditioner arrangement with a combustible and/or highly flammable coolant.

In order to solve the object underlying the invention, an air conditioner arrangement for a switch cabinet is suggested, comprising a housing with a cabinet side housing area and an external housing area, comprising a partition wall arranged between the cabinet side housing area and the external housing area, separating the cabinet side housing area and the external housing area from each other fluidically, and comprising a first heat exchanger that extends through the partition wall, wherein the first heat exchanger is an air-liquid heat exchanger, with an evaporator section arranged in the external housing area, and with a heat absorption section coupled thermally with the evaporator section and arranged in the cabinet side housing area to take up the heat from the cabinet side housing area and transfer the heat to the evaporator section by thermal conduction, wherein a coolant circuit containing a, in particular combustible and/or toxic, coolant is arranged in the external housing area in such manner that the heat from the cabinet side housing area delivered to the evaporator section can be transferred to the coolant circuit.

According to the invention, the first heat exchanger is an air-liquid heat exchanger. This means that the first heat exchanger removes heat from a volume of air and transfers it to a liquid, in particular the coolant. In this process, the heat is extracted from the air in particular in the cabinet side housing area, while the heat is transferred to the liquid in the external housing area.

Inside the first heat exchanger, in particular from the heat absorption section to the evaporator section, the thermal energy in the air is transported, in particular exclusively, via thermal conduction. In particular, there is no coolant or cooling fluid in the heat absorption section of the first heat exchanger. Moreover, preferably no heat convection or thermal radiation takes place inside the heat absorption section of the first heat exchanger. In the first heat exchanger, the heat from the air in the cabinet side housing area is transferred to the coolant or liquid in the external housing area, thus in particular via thermal conduction in a solid material without material movement. The heat absorption section of the first heat exchanger is thus in particular passive. A convective transfer of heat with no material exchange (i.e. no material transport) can occur during the transfer of heat from the air in the cabinet side housing area to the heat absorption section and when the heat is surrounded by the evaporator section to a coolant and/or air in the external housing area.

Since the transfer of heat from the cabinet side housing area to the external housing area takes place in the heat absorption section and the evaporator section solely via thermal conduction, the use of combustible coolant in the cabinet side housing area can advantageously be dispensed with, thereby minimising or almost entirely eliminating the risk of explosion to good effect . A heat exchanger that transfers heat exclusively by thermal conduction can also be produced simply and inexpensively, since such apparatuses are typically of simple construction.

The heat absorption section of the first heat exchanger is preferably formed from a solid material, that is to say the heat absorption section in particular contains no internal, closed cavities.

The cabinet side housing area is preferably open towards the switch cabinet or is fluidically connected to it, so that air warmed by the components in the switch cabinet is able to reach the heat absorption section of the first heat exchanger. At least one displacement device, for example a blower or fan, may preferably be provided to move the warmed air in the switch cabinet to the heat absorption section.

The external housing area is preferably open to the surrounding area, or can be opened to the surrounding area, to enable the heat that was transferred into the external housing area or the coolant circuit in the external housing area via the first heat exchanger to escape into the surrounding area. For this purpose, an opening may be provided in the housing of the external housing area, for example. A fan, blower, outlet filter, etc. may also be arranged in this opening.

The coolant circuit preferably runs through the evaporator section. This creates a thermal coupling between the evaporator and the coolant in the coolant circuit, so that the heat from the evaporator section can be transferred to the coolant by thermal conduction. The coolant circuit may for example include one or more lines for the coolant, portions of which is/are thermally coupled with the evaporator. The coolant circuit may also include a further heat exchanger, via which the heat from the coolant can be discharged to the surrounding area.

The evaporator section and the heat absorption section are preferably constructed as a single part. This enables a particularly simple construction. In particular, the evaporator section and the heat absorption section are produced from the same material, in particular with high thermal conductivity. In particular, the evaporator section and the heat absorption section are created in a single component.

Alternatively, the heat absorption section and the evaporator section may preferably two separate components, which are connected to one another in particular by joining means. The heat absorption section and the evaporator section may be produced from the same material or different materials. The materials may be for example aluminium, steel, copper and/or a ceramic material.

The first heat exchanger is preferably arranged in an opening in the partition wall, and the first heat exchanger closes off the opening, in particular so as to be impermeable to fluids. In addition, a sealing device may preferably be arranged between the first heat exchanger and the partition wall.

The heat absorption section and/or the evaporator section is/are preferably formed by a flat section of the first heat exchanger, wherein the flat section extends substantially over an entire opening area of an opening in the partition wall. The flat sections advantageously provide a large surface area for effective heat transfer.

In particular, the heat exchanger has an in particular flat main body which preferably comprises the flat sections.

The main body of the first heat exchanger is preferably constructed substantially in the form of a plate. This plate form advantageously provides a large surface area for heat transfer, while at the same time the thermal conduction must take place over only short portions of material, which thus further enhances the efficiency of the heat transfer from the cabinet side housing area into the external housing area.

The in particular flat main body of the first heat exchanger preferably extends substantially parallel to the partition wall. In particular, the main body of the first heat exchanger or the flat sections thereof extend(s) parallel to the opening or opening area in der partition wall.

A first side of the flat main body preferably forms the heat absorption section and is orientated towards the cabinet side housing area.

A second side of the first heat exchanger, opposite the first side of the flat main body, preferably forms the evaporator section and is orientated towards the housing area.

Preferably an entire surface area of the first and/or second side form areas of the heat absorption section and the evaporator section respectively. In particular, the first heat exchanger is thus formed by a plate, which is set into the opening in the partition wall in the area of its peripheral outer edge. The first side fully faces the cabinet side housing area, and the second side fully faces the external housing area. In other words, the first heat exchanger may be considered as a section of the partition wall.

The first heat exchanger preferably has a multiplicity of heat transfer bodies, in particular cooling fins, on the heat absorption section, which fins extend into the cabinet side housing area. If the heat transfer bodies are configured as cooling fins, the cooling fins are preferably arranged parallel to each other. Alternatively, the heat transfer bodies may be cooling pins or may be any other shape suitable for effective heat transfer. The heat transfer bodies may be constructed integrally with the heat absorption section, or the heat transfer bodies and the heat absorption section may be separate elements. The heat transfer bodies may preferably contain aluminium, steel, copper and/or a ceramic material, or they may be made from aluminium, steel, copper and/or a ceramic material.

The heat transfer bodies preferably extend over the entire heat absorption section.

The coolant circuit is preferably located entirely in the external housing area. In particular, all coolant lines and connectors for the coolant lines are arranged in the external housing area. In addition, particularly all leak-susceptible areas and sections such as pipe bends or pipe joints of the coolant lines are located in the external air flow. Accordingly, the coolant circuit is not arranged in the cabinet side housing area and in particular there is no coolant in the cabinet side housing area. In this way, combustible coolant is prevented from getting into the switch cabinet. The heat exchanger may be considered safe in respect of leak-prone areas. Consequently, the heat exchanger can be used without consideration for the interior volume of the switch cabinet. Expensive safety apparatuses, for gas detection for example, therefore do not need to be provided in the switch cabinet. The coolant circuit is preferably an active circuit. Accordingly, the coolant circuit preferably includes components such as a condenser, an evaporator, a compressor and/or expansion means.

The evaporator section preferably comprises at least one coolant transport section, wherein the coolant transport section is coupled to the heat absorption section of the first heat exchanger. In particular, the coolant transport section is or can be coupled to the coolant circuit. The coolant transport section preferably contains the coolant and/or the coolant flows through it. The coolant transport section may thus form a part or section of the coolant circuit. The thermal coupling between the coolant transport section and the heat absorption section takes place in particular by thermal conduction. The coolant transport section may preferably be in the form of a component, for example one or more pipe sections, or it may be an area inside the evaporator section through which the coolant can flow.

The coolant circuit preferably contains propane as coolant. Alternatively, the coolant circuit may contain other combustible or potentially explosive coolants. Since the coolant circuit and thus also the coolant are contained entirely in the external housing area, the risk of explosion associated with potential contact between the coolant and the components in the switch cabinet can be effectively minimised.

The coolant transport section is preferably at least one coolant line, wherein the coolant transport section preferably comprises a multiplicity of separate coolant lines. In this way, the heat may be transferred from the evaporator section to the coolant in the coolant lines or coolant lines sections and then dissipated into the surrounding area via the coolant circuit. In particular, the coolant lines may be pipes or pipe sections.

The coolant line or coolant lines may preferably be formed by one or more boreholes in the evaporator section or the material of the evaporator section. According to this variant, the coolant lines are not formed by a separate component, such as pipes, for example, but by a recess or an area inside the evaporator section. Coolant lines which run outside the evaporator section and the first heat exchanger and are part of the coolant circuit may be connected to the boreholes.

The at least one coolant line may also be formed by at least one recess, e.g., created by milling, in one or both of two separate heat exchanger components that form the first heat exchanger. The two heat exchanger components may be shaped such that when the two heat exchanger components are assembled the coolant line is formed between the two heat exchanger components. For this purpose, either one of the heat exchanger components or both heat exchanger components may have an elongated recess, like a groove, so that when they are assembled a channel that is completely closed except for the ends is formed, creating the coolant line.

A pipe may preferably be pressed into the recess to form the coolant line.

The recess may preferably be created by milling.

The at least one coolant line may preferably have a round or angled cross-section. Accordingly, the coolant line may also be formed by one or two recesses with an angled or round – or semicircular – cross-section.

The coolant line is preferably located on or in the evaporator section.

The coolant line is preferably a pipeline which is integrated in, particularly pressed into, the evaporator section. Integrating the coolant line in the evaporator section advantageously creates a large contact surface between the evaporator section and the coolant lines, which favourably enhances the efficiency of heat transfer. The evaporator section preferably contains corresponding depressions, into which the coolant line sections are recessed.

The coolant lines preferably run parallel to each other. The parallel coolant lines preferably run over the entire evaporator section.

First end sections of the coolant lines are preferably connected to a first manifold stage.

Second end sections of the coolant lines are preferably connected to a second manifold stage.

A single coolant line may preferably be provided, extending in meandering manner through the evaporator section. Pipe bends created by the meandering routing may extend outside of the evaporator section and heat exchanger, so that they are exposed, or in the material of the evaporator section so that they are enclosed.

If the coolant lines are not formed by pipelines, but by boreholes or recesses (such as milled recesses) in the evaporator section, connection line sections may be provided that run between the borehole ends of the coolant lines and the first or second manifold stage, connecting the borehole ends fluidically with the manifold stages.

The coolant transport section may preferably also have another form, and may be a plate heat exchanger, for example, or any other form that enables an effective transfer of heat from the evaporator section to the coolant.

The first heat exchanger may preferably be configured as a component or component unit separate from the coolant circuit and partition wall. For this purpose, the second heat exchanger is equipped in particular with connectors for connecting the first heat exchanger, in particular the coolant lines, to the coolant circuit.

The air conditioner arrangement preferably comprises a thermal isolation device for the thermal isolation of at least portions of the evaporator section. In particular, the thermal isolation device is arranged in the external housing area. The effectiveness of heat transfer from the evaporator section to the coolant or coolant circuit may be enhanced by the isolation device, as the heat is not transferred to the air in the external housing area but directly to the coolant, with the result that the heat can be effectively dissipated into the surrounding area via the coolant circuit, since this prevents any heat from being transferred from the external housing area or the surrounding area to the coolant circuit.

The object according to the invention is also solved with an air conditioner arrangement for a switch cabinet, comprising a housing with a cabinet side housing area and an external housing area, comprising a partition wall that is arranged between the cabinet side housing area and the external housing area and separates the cabinet side housing area and the external housing area from each other fluidically, and comprising a first heat exchanger that protrudes through the partition wall, with an evaporator section arranged in the cabinet side housing area, and a heat absorption section coupled thermally with the evaporator section and arranged in the external housing area to absorb the heat from the external housing area and transfer the heat to the evaporator section by means of thermal conduction, wherein a coolant circuit, containing a, in particular toxic coolant, is arranged in the cabinet side housing area in such manner that the heat from the external housing area delivered to the evaporator section can be transferred to the coolant circuit.

The air conditioner arrangement is in particular a heat pump assembly for transporting heat from the surrounding area into the cabinet side housing area. This is particularly advantageous in application situations in which the intention is not to cool the switch cabinet, but rather to heat it. The coolant circuit is then arranged in the cabinet side housing area. Particularly when a toxic coolant is used, this is advantageous in that, in the event of a leak the toxic coolant remains in the switch cabinet or in the cabinet side housing area and cannot escape to the outside via the external housing area, where it may endanger people.

The object according to the invention is also solved with an air conditioner arrangement for a switch cabinet, comprising a housing with a cabinet side housing area and an external housing area, comprising a partition wall that is arranged between the cabinet side housing area and the external housing area and separates the cabinet side housing area and the external housing area from each other fluidically, and comprising a first heat exchanger that protrudes through the partition wall, with a condenser section arranged in the cabinet side housing area, and a heat absorption section coupled thermally with the condenser section and arranged in the external housing area to absorb the heat from the condenser section by thermal conduction and transfer the heat to the external housing area, wherein a coolant circuit, containing a, in particular toxic coolant, is arranged in the cabinet side housing area in such manner that the heat from the cabinet side housing area can be transferred to the condenser section from the coolant circuit.

The air conditioner arrangement cools the switch cabinet or removes heat from it and removes the heat via the heat exchanger and the external housing area to the outside surrounding area. The coolant circuit is arranged in the cabinet side housing area. Particularly when a toxic coolant is used, this is advantageous in that, in the event of a leak the toxic coolant remains in the switch cabinet or in the cabinet side housing area and cannot escape to the outside via the external housing area, where it may endanger people.

The object according to the invention is further solved with a switch cabinet having an air conditioner arrangement as described in the preceding text. The housing as described previously may in particular be a housing of the switch cabinet.

### BRIEF DESCRIPTION OF THE FIGURES

The invention will be explained in greater detail with reference to the figures. These show:

FIG. 1a a first sectional view through a part of an air conditioner arrangement with a coolant line according to a first embodiment,

FIG. 1b a second sectional view through a part of an air conditioner arrangement with the coolant line according to the first embodiment,

FIG. 2a a first sectional view through a part of an air conditioner arrangement with a coolant line according to a second embodiment,

FIG. 2b a second sectional view through a part of an air conditioner arrangement with the coolant line according to the second embodiment,

FIG. 3 a perspective view of a first heat exchanger of the air conditioner arrangement with the coolant line according to the second embodiment,

FIG. 4a, b cut views of the first heat exchanger of the air conditioner arrangement according to different embodiments with pipe bends,

FIG. 5a, b sectional views of the first heat exchanger of the air conditioner arrangement according to different embodiments with straight coolant line routing,

FIG. 6a, b, c various embodiments of a sealing area between a partition wall and the first heat exchanger,

FIG. 7a, b various embodiments of the arrangement of coolant lines in the first heat exchanger,

FIG. 8a-j various embodiments of the configuration of the coolant lines in the first heat exchanger, and

FIG. 9 a schematic view of a switch cabinet housing with the air conditioner arrangement.

### DETAILED DESCRIPTION OF THE FIGURES

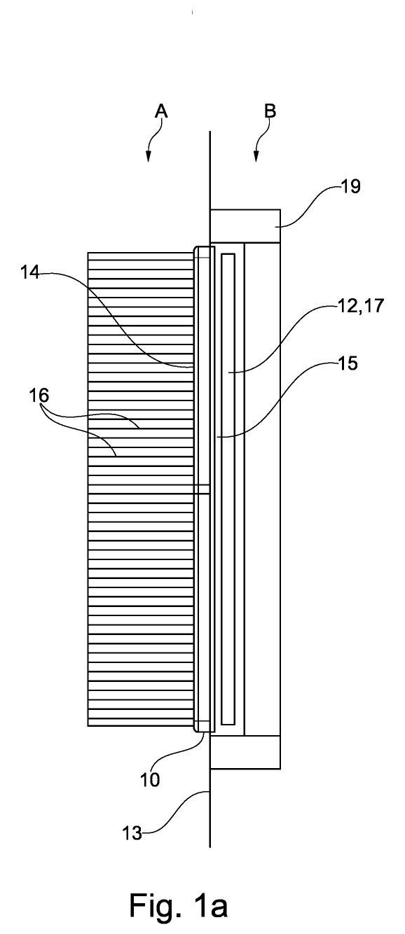

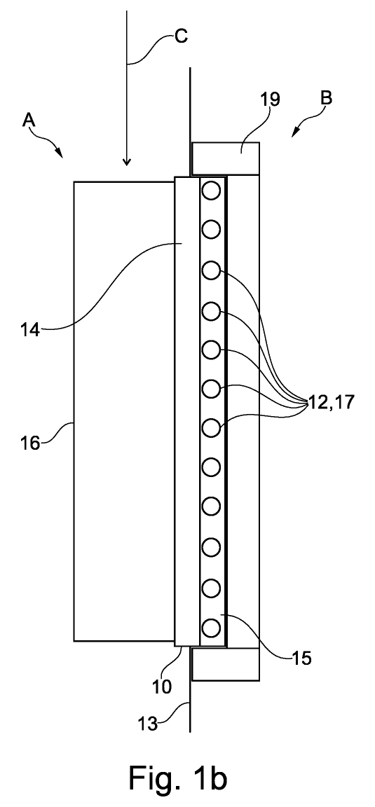

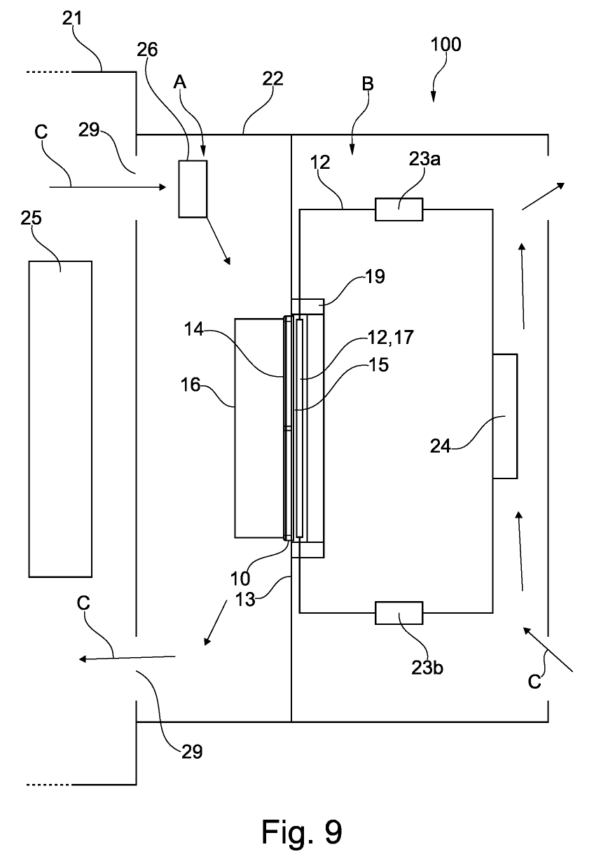

FIG. 1a shows a part of an air conditioner arrangement 100 according to a first embodiment for a switch cabinet (not shown) in a first sectional view along a flow direction of the cooling air or in the direction of a longitudinal extension of heat transfer bodies 16 of the air conditioner arrangement, each of which are formed by cooling fins arranged parallel to each other. In the representation shown in FIG. 1a, the cooling air flows in the direction of the plane of the drawing and thus parallel to and along the cooling fins. The air conditioner arrangement 100 is arranged on a switch cabinet 21 and comprises a housing 22 (FIG. 9) with a cabinet side housing area A and an external housing area B, wherein the two housing areas A, B are separated from one another fluidically by a partition wall 13, so that in particular no coolant from the external housing area B can get into the cabinet side housing area A.

The cabinet side housing area A is arranged adjacent to the switch cabinet 21, in which heat generating electronic components 25 are located. The cabinet side housing area A is fluidically connected to the switch cabinet via openings 29, i.e. warm air flows into the cabinet side housing area A of the air conditioner arrangement 100 from the switch cabinet 21, and after heat transfer has taken place the cooled air flows back into the switch cabinet again (indicated by the flow arrows for the air C). In order to remove the heat from the cabinet side housing area A, a first heat exchanger 10 is provided, arranged in the partition wall 13. In particular, the first heat exchanger 10 is arranged in an opening in the partition wall 13 and extends through the partition wall 13.

The first heat exchanger 10 is constructed the form of a plate, with a heat absorption section 14 on one side of the first heat exchanger 10, facing towards the cabinet side housing area A. Through the heat absorption section 14, uptake of the heat from the cabinet side housing area A takes place via heat transfer bodies 16 in the form of cooling fins, which extend into the cabinet side housing area A are preferably arranged parallel to the flow direction of the air.

The heat is transferred to an evaporator section 15 of the first heat exchanger 10 by thermal conduction, wherein the evaporator section 15 is arranged on a side of the heat exchanger 10 facing the external housing area B or forms this side of the first heat exchanger 10. The heat absorption section 14 and the evaporator section 15 are parts of a single plate-like element.

Through the evaporator section 15, the heat is passed to a coolant circuit 12 in the external housing area B. The coolant circuit 12 comprises coolant line sections 17, which are arranged in the evaporator section 15 and/or are routed through the evaporator section 15. According to this first embodiment, the coolant line sections 17 run transversely to a longitudinal extension of the cooling fins. In other words, the cooling fins and the coolant line sections 17 are aligned to intersect with each other. The heat is transferred from the evaporator section 15 to the coolant in the coolant line sections 17. The warmed coolant is transported onwards in the coolant circuit 12, and the heat is discharged into the surrounding area via the coolant circuit 12 or the further components thereof, additional heat exchangers for example.

The air conditioner arrangement is further equipped with an isolation device 19, which surrounds the evaporator section 15 and a region of the coolant circuit 12 where the heat is transferred from the evaporator section 15 to the coolant in the coolant circuit 12. In particular, the isolation device 19 surrounds the evaporator section 15 and the coolant line sections 17 that pass through the evaporator section 15.

FIG. 1b shows the air conditioner arrangement 100 according to the first embodiment in a second sectional view along a longitudinal extension of the coolant lines 17 and parallel to the longitudinal extension of the cooling fins. The intersecting axis of the sectional view of FIG. 1b is therefore rotated through 90° compared with the intersecting axis der sectional view in FIG. 1a. In the view in FIG. 1b, the direction of flow C of the cooling air in the cabinet side housing area A runs from top to bottom, so that the cooling air can flow between and through the cooling fins. Otherwise, the second and first embodiments are substantially of the same construction, and the preceding notes regarding the first embodiment apply similarly for the second embodiment.

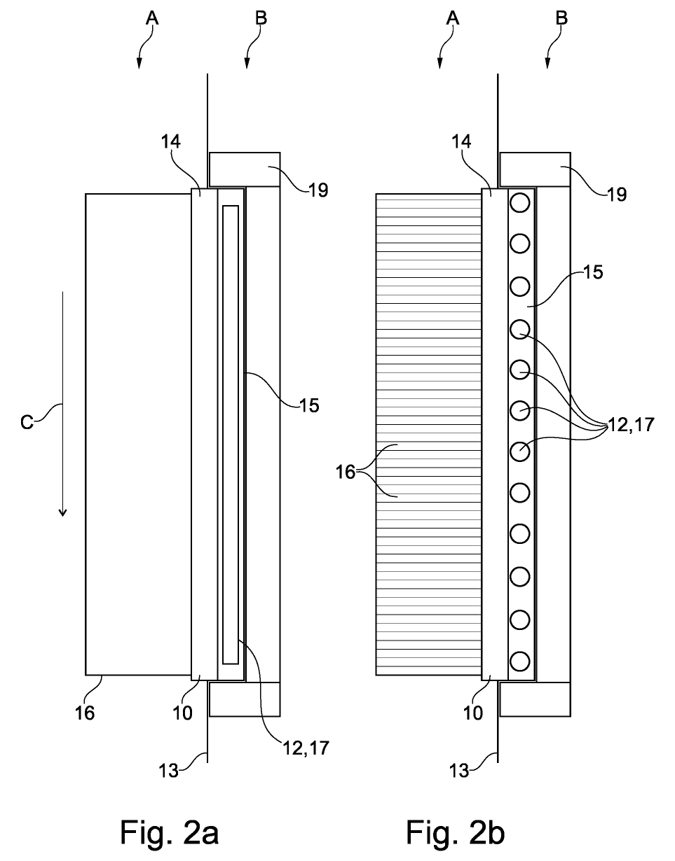

FIGS. 2a and 2b show two sectional views of the air conditioner arrangement 100 according to a second embodiment, which differs from the embodiment shown in FIGS. 1a and 1b in the arrangement of the cooling fins relative to the coolant lines 17. In this case, the coolant lines 17 run parallel to a longitudinal extension of the cooling fins, which form the heat transfer bodies 16. In other words, the cooling fins and the coolant line sections 17 are aligned parallel to each other.

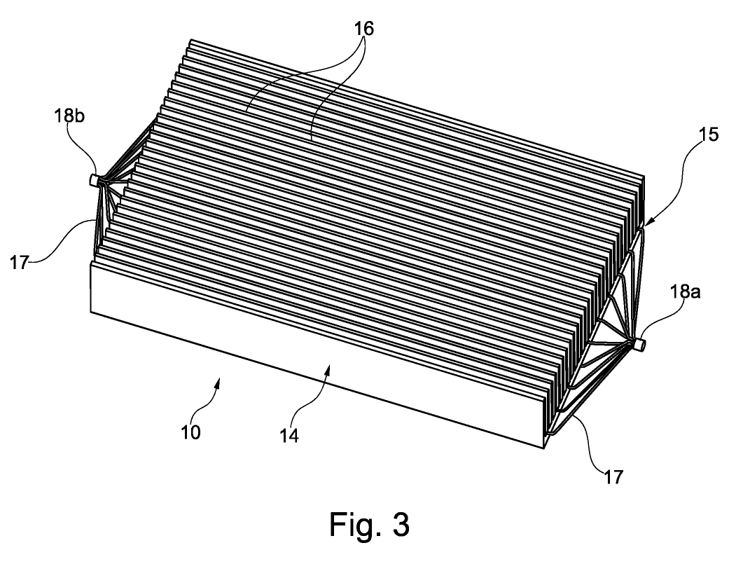

FIG. 3 shows a perspective view of the first heat exchanger 10. The first heat exchanger 10 includes a number of heat transfer bodies 16 in the form of cooling fins, which extend parallel to each other over the entire heat absorption section 14 of the first heat exchanger 10. In particular, the heat transfer bodies 16 protrude perpendicularly from the heat absorption section 14.

FIG. 3 further shows a multiplicity of coolant line sections 17 that extend through the evaporator section 15 of the first heat exchanger 10 according to the second embodiment. At two opposite ends of the evaporator section 15, the coolant line sections 17 are merged in a first manifold stage 18a and a second manifold stage 18b respectively, so that the coolant can be transported from the coolant line sections 17 to the subsequent course of the coolant circuit 12. As illustrated in FIG. 2, the first heat exchanger with the coolant line sections 17 may be embodied as a separate component or component unit. The cooling fins and the coolant line sections 17 are routed parallel to each other, so this arrangement corresponds to the arrangement of FIGS. 2a and 2b.

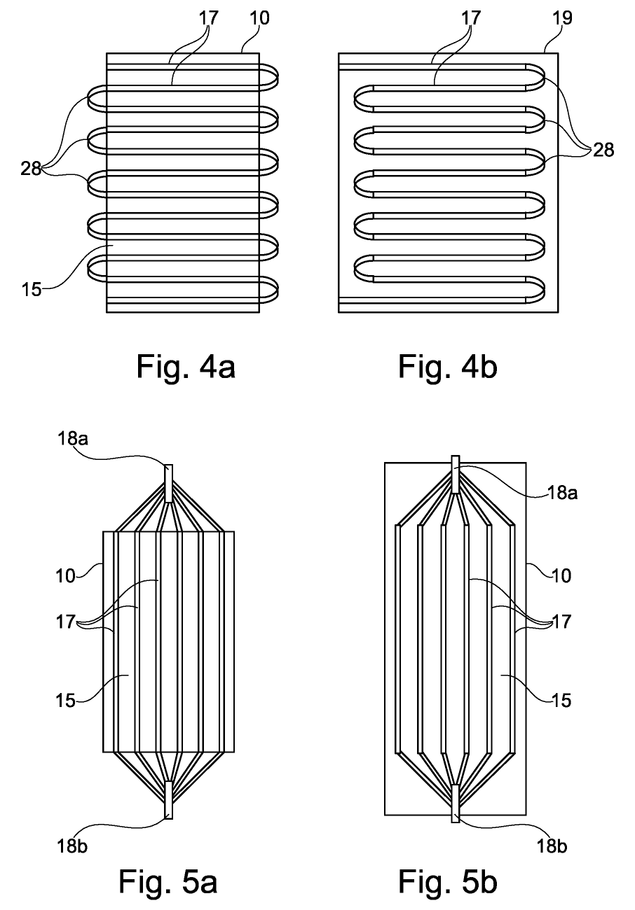

FIGS. 4a and 4b show sectional views of the evaporator section 15 in the first heat exchanger 10 according to various embodiments. The meandering course of a coolant line 17 of the coolant circuit 12 is illustrated. The coolant line 17 comprises pipe bends 28, which are arranged outside the evaporator section 15 in the embodiment represented in FIG. 4a, whereas in the embodiment of FIG. 4b the pipe bends are routed inside the evaporator section 15.

FIGS. 5a and 5b show sectional views of the evaporator section 15 of the first heat exchanger 10 according to various embodiments, wherein the coolant lines 17 run in a straight line between two manifold stages 18a, 18b. In FIG. 5a, the manifold stages 18a, 18b are arranged outside the evaporator section 15, while the manifold stages 18a, 18b in the embodiment shown in FIG. 5b are routed inside the evaporator section 15.

In principle, it is also possible to combine the embodiments of FIGS. 4a and 4b with the embodiments of FIGS. 5a and 5b. For example, different meandering coolant lines might open into a common manifold stage.

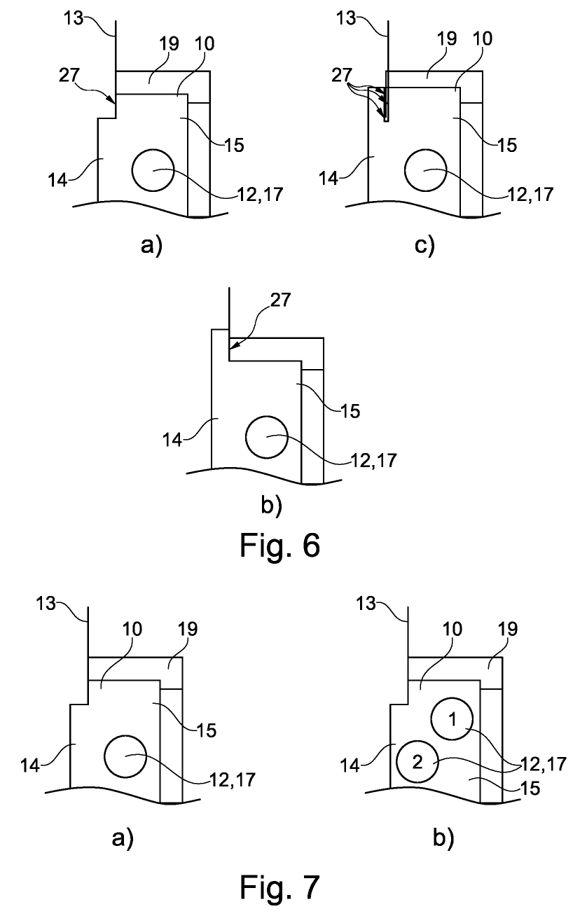

FIGS. 6 a-c show different variants of a seal area 27 between the first heat exchanger 10 and the partition wall 13.

As shown in FIG. 6a, the first heat exchanger 10 may have a step-like recess on an edge facing the partition wall 13, so that a sealing surface facing the cabinet side housing area A is formed in the region of the recess, with which the partition wall 13 is in contact.

In the embodiment according to FIG. 6b, the recess with the sealing surface faces the external housing area B.

In the embodiment shown in FIG. 6c, the first heat exchanger 10 has a slot-like depression whose interior walls form the sealing surfaces. The partition wall 13 extends into the slot-like depression.

FIGS. 7a and 7b show cross-section views through a region of the first heat exchanger 10, showing the arrangement of the coolant lines 17. In FIG. 7a, the coolant lines 17 run in one plane, whereas the coolant lines 17 in the embodiment shown in FIG. 7b are arranged in two planes.

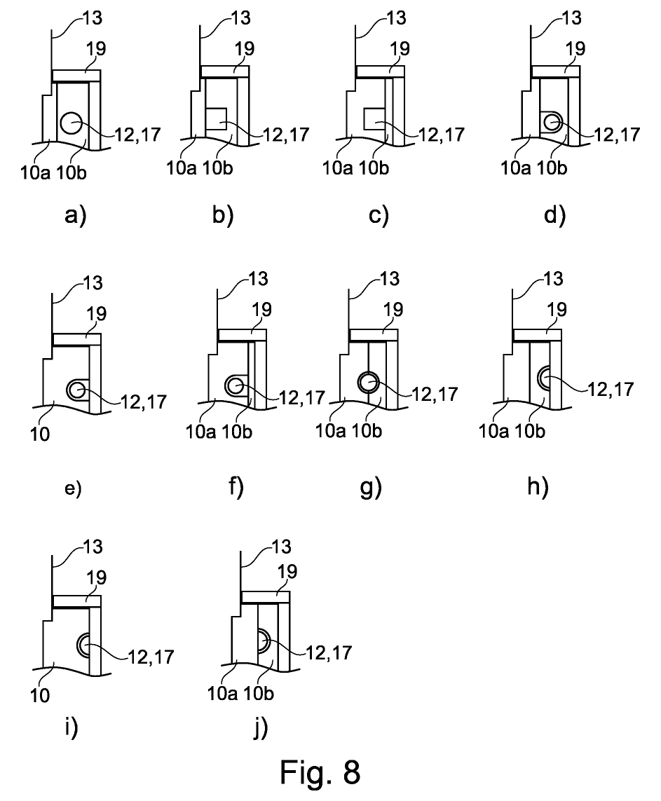

FIGS. 8a to 8j show various embodiments for a coolant line in the first heat exchanger 10.

With the exception of FIGS. 8e and 8i, the first heat exchanger 10 is formed by two heat exchanger components 10a, 10b. In FIG. 8a, the coolant line 17 is formed by a borehole in one of the two heat exchanger components 10b.

In FIGS. 8b, 8c, 8d, 8f, 8g and 8j an angular or round or semicircular recess is created respectively in one or both heat exchanger components 10a, 10b, wherein either the recess itself forms the coolant line 17 (FIGS. 8b, 8c) or pipes or flat pipes are pressed into the recess to form the coolant line 17 (FIG. 8d, FIGS. 8f to 8h, and FIG. 8j). If a recess is only created in one of the two heat exchanger components 10a, 10b (FIGS. 8b, 8c, 8d, 8f, 8j), the other heat exchanger component 10a, 10b in each case has no recess and functions as a cover-like element. The recesses may have an angular cross-section (FIGS. 8b and 8c) and may be cut into one of the heat exchanger components 10a, 10b by milling. The round recesses (FIGS. 8d to 8j) may also be created by milling.

FIG. 9 shows the air conditioner arrangement 100 arranged on a switch cabinet 21. In particular, the air conditioner arrangement 100 is arranged on a switch cabinet housing, and air from the switch cabinet 21, in which at least one electrical component 25 is located, can pass into the cabinet side housing area A through a top and a bottom opening 29 in the switch cabinet housing; in the cabinet side housing area it is cooled by the first heat exchanger and then returned to the interior of the switch cabinet 21 again through the bottom opening. This is indicated accordingly by arrows C in FIG. 9. A blower 26 is provided in this region to displace the air. The air conditioner arrangement 100 comprises a housing 22 with the cabinet side housing area A and the exterior housing area B, which are separated from one another by the partition wall 13. The first heat exchanger 10 of the air conditioner arrangement 100 is arranged in the partition wall 13 or a cutout in the partition wall 13, the dimensions of the first heat exchanger 10 being adapted to the size of the cutout in the partition wall 13, so that the first heat exchanger 10 fits into the partition wall 13 as closely as possible, without any gaps. In the illustration of FIG. 9, the heat transfer bodies 16 in the form of cooling fins extend parallel to the coolant lines 17. Sealing means or the like may preferably be provided in the border region of the cutout in the partition wall, to ensure that partition wall 13 is impermeable to fluids, even when the heat exchanger 10 is inserted therein.

The first heat exchanger 10 absorbs the heat from the cabinet side housing area A and transmits it to the coolant circuit 12 in the external housing area B. The coolant circuit 12 comprises components 23a, 23b of a conventional coolant circuit, such as a compressor, expansion elements, etc. In principle, the coolant circuit 12 may take in more than the two components 23a, 23b represented. The coolant circuit 12 further includes a second heat exchanger 24, in particular a condenser, via which the heat from the coolant may be discharged into the surrounding area, as indicated by the arrows in FIG. 3. Corresponding top and bottom openings are provided in the housing 22 in external housing area B to allow the inflow and removal of air from and into the surrounding area. Blowers (not shown here) may be provided at the openings to displace the air in this region.

1. Air conditioner arrangement for a switch cabinet, comprising a housing with a cabinet side housing area and an external housing area, comprising a partition wall arranged between the cabinet side housing area and the external housing area, which separates the cabinet side housing area and the external housing area fluidically from each other, and comprising a first heat exchanger that extends through the partition wall, wherein the first heat exchanger is an air-liquid heat exchanger, with an evaporator section arranged in the external housing area and with a heat absorption section coupled thermally with the evaporator section and arranged in the cabinet side housing area to take up the heat from the cabinet side housing area and transfer the heat to the evaporator section by thermal conduction, wherein a coolant circuit containing a, in particular combustible and/or toxic, coolant is arranged in the external housing area, in such a manner that the heat from the cabinet side housing area delivered to the evaporator section can be transferred to the coolant circuit.

2. Air conditioner arrangement according to claim 1, wherein the evaporator section and the heat absorption section are constructed as a single piece.

3. Air conditioner arrangement according to claim 1, wherein the first heat exchanger is arranged in an opening in the partition wall, wherein the first heat exchanger seals off the opening, in particular in a fluid-impermeable manner.

4. Air conditioner arrangement according to claim 1, wherein the heat absorption section and/or the evaporator section is/are formed by a flat section of a main body of the first heat exchanger, wherein the flat section extends substantially over an entire opening area of an opening in the partition wall.

5. Air conditioner arrangement according to claim 4, wherein the main body of the first heat exchanger is constructed substantially in the form of a plate.

6. Air conditioner arrangement according to claim 4, wherein the main body of the first heat exchanger extends substantially parallel to the partition wall.

7. Air conditioner arrangement according to claim 5, wherein a first side of the main body of the first heat exchanger forms the heat absorption section and is orientated towards the cabinet side housing area.

8. Air conditioner arrangement according to claim 1, wherein a second side of the first heat exchanger, which is positioned opposite the first side of the main body of the first heat exchanger, forms the evaporator section and is orientated towards the external housing area.

9. Air conditioner arrangement according to claim 1, wherein the first heat exchanger has a multiplicity of heat transfer bodies, in particular cooling fins, on the heat absorption section, which fins protrude into the cabinet side housing area.

10. Air conditioner arrangement according to claim 1, wherein the coolant circuit is arranged entirely inside the external housing area.

11. Air conditioner arrangement according to claim 1, wherein the coolant circuit comprises propane as coolant.

12. Air conditioner arrangement according to claim 10, wherein the evaporator section comprises a coolant transport section, wherein the coolant transport section is thermally coupled to the heat absorption section of the first heat exchanger.

13. Air conditioner arrangement according to claim 12, wherein the coolant transport section comprises or is at least one coolant line, wherein the coolant transport section preferably includes a multiplicity of coolant lines.

14. Air conditioner arrangement according to claim 13, wherein the coolant line is arranged on the evaporator section, wherein preferably the coolant line is integrated in, in particular pressed into, the evaporator section.

15. Air conditioner arrangement according to claim 13, wherein the coolant transport section comprises a multiplicity of coolant lines running parallel to each other, which are thermally coupled to the evaporator section.

16. Air conditioner arrangement according to claim 15, wherein first end sections of the coolant lines are connected to a first manifold stage, and/or wherein second end sections of the coolant lines are connected to a second manifold stage.

17. Air conditioner arrangement according to claim 1, comprising a thermal isolation device for thermal isolation of at least portions of the evaporator section.

18. Air conditioner arrangement for a switch cabinet, comprising a housing with a cabinet side housing area and an external housing area, comprising a partition wall arranged between the cabinet side housing area and the external housing area which separates the cabinet side housing area and the external housing area fluidically from each other, and comprising a first heat exchanger that protrudes through the partition wall, with an evaporator section arranged in the cabinet side housing area and a heat absorption section which is arranged in the external housing area and thermally coupled with the evaporator section to take up the heat from the external housing area and transfer the heat to the evaporator section by thermal conduction, wherein a coolant circuit, in particular containing a toxic coolant, is arranged in the cabinet side housing area in such a manner that the heat from the external housing area delivered to the evaporator section can be transferred to the coolant circuit.

19. Air conditioner arrangement for a switch cabinet, comprising a housing with a cabinet side housing area and an external housing area, comprising a partition wall arranged between the cabinet side housing area and the external housing area which separates the cabinet side housing area and the external housing area fluidically from each other, and comprising a first heat exchanger that protrudes through the partition wall, with a condenser section arranged in the cabinet side housing area and a heat absorption section which is arranged in the external housing area and thermally coupled with the condenser section to take up heat from the condenser section by thermal conduction and transfer the heat to the external housing area, wherein a coolant circuit, in particular containing a toxic coolant, is arranged in the cabinet side housing area in such a manner that the heat from the cabinet side housing area can be delivered to the condenser section by the coolant circuit.

20. Switch cabinet having an air conditioner arrangement according to claim 1.
